(19) United States
(12) Patent Application Publication
(10) Pub. No.: US 2013/0149028 A1
(43) Pub. Date: Jun. 13, 2013

(54) LOCKING DEVICE

(71) Applicant: DET INTERNATIONAL HOLDING LIMITED, George Town (KY)

(72) Inventor: Markus BOLLENBACH, Bern (CH)

(73) Assignee: DET INTERNATIONAL HOLDING LIMITED, George Town (KY)

(21) Appl. No.: 13/708,633

(22) Filed: Dec. 7, 2012

(30) Foreign Application Priority Data
Dec. 9, 2011 (EP) 11405365.5

(51) Int. Cl. F16B 17/00

(52) U.S. Cl. CPC F16B 17/00
USPC 403/325; 403/321

(57) ABSTRACT

A device for locking a unit (2) in a holder (1), having a first locking element (3), which has a first latching element (4) and is contained by the unit (2), and having a second locking element (5), which has a second latching element (5) and is contained by the holder (1), wherein at least one of the locking elements (3, 5) is mounted in a movable manner and can be subjected to force for the purpose of locking the two latching elements (4, 5), and wherein the locking device comprises a first stop (18), for limiting maximum deflection of the movable locking element (3), the locking device comprises a second stop (19), for limiting overlapping of the two latching elements (3, 5) in the locked state.

### TECHNICAL FIELD

The invention relates to a locking device for locking a plug-in unit in a holder. Plug-in units which are plugged into a holder, a rack or a shelf establish, upon reaching an end position in the holder, an electromechanical connection to the holder, e.g. a backplane. The locking device of the plug-in unit serves to secure the plug-in unit in the end position, and therefore vibration or jarring motion cannot release the unit from the defined end position. It is possible for such a locking device to be released only manually by a user and for the plug-in unit to be pulled out of the holder.

### PRIOR ART

The prior art already discloses locking devices for locking plug-in units in holders or racks.

For example, DE 198 27 074 A1 (FESTO AG & Co) discloses a retaining device which serves for fastening a plug-in card in a plug-in housing. It comprises at least one retaining element which has latching means which, with the plug-in card plugged in, comes into latching engagement with latching counterparts of the respectively other component. The retaining element has a resilient element which prestresses the latching means into their retaining position. When the plug-in card is being plugged into the plug-in housing, the latching means latches automatically into a plug-in position.

DE 3146904 A1 (Standard Elektrik Lorenz AG) describes a locking device for communications-engineering modules which can be plugged into mounting racks. It comprises a resilient crosspiece which is suitable for allowing the locking device, when the module is being plugged into the mounting rack, to latch into a transverse groove of the mounting rack.

However, the known locking devices have different disadvantages. Thus, for example, the operations of plugging a plug-in unit into the holder and of pulling it out of the same are not always readily possible. It is also the case that many known locking devices do not ensure that units which have not been plugged in completely correctly are also locked reliably in the holders.

### DISCLOSURE OF THE INVENTION

It is an object of the invention to eliminate, or to reduce, the disadvantages of the prior art. In particular it is an object of the invention to provide a locking device which is as straightforward to use as possible and allows reliable and secure locking of plug-in units in holders, specifically even in the case of low-level and/or difficult conditions.

The object is achieved by the subject matter of claim 1 in that the locking device comprises a first stop, for limiting maximum deflection of a locking element, and a second stop, for limiting overlapping of two latching elements.

The invention has the advantage over the prior art that mechanical tolerances are compensated for automatically, as a result of which the plug-in unit remains securely locked. In addition, deformation caused by external influences is compensated for automatically which further allows a secure locking of the plug-in unit. In addition, movements of the plug-in unit are compensated for with the aid of the invention, which results in the plug-in unit remaining securely locked even in the event of such movements.

A locking device according to the present invention for locking a unit in a holder has a first locking element, which has a latching element and is contained by the unit, and has a second locking element, which has a second latching element and is contained by the holder, wherein at least one of the locking elements is mounted in a movable manner and may be subjected to a force for the purpose of locking the two latching elements. The locking device comprises a first stop, for limiting the maximum deflection of the movable locking element or for defining a maximum-deflection position of the movable locking element. A locking device according to the present invention comprises a second stop, for limiting the overlapping of the two latching elements in the locked state or for defining a maximum overlapping of the two latching elements in the locked state. In the case of typical embodiments, the second locking element is the second latching element. In the case of typical embodiments, the two stops are arranged such that, when the two locking elements are being locked, the movable locking element strikes against the second stop before it strikes against the first stop. This is the case both when the unit is located in a normal position in the holder and when the unit has not been introduced correctly into the holder. In the latter case, the fact that there is still a certain spacing present between the movable locking element and the first stop when the locking element strikes against the second stop means that it is possible to compensate for a spacing which has occurred between a unit housing and the holder on account of the unit not being introduced correctly.

In advantageous embodiments, the locking device comprises a spring element for subjecting the movable latching element and/or the movable locking element with the force. As an alternative, it is also possible for the first element itself to be heavy enough such that it may be subjected with the force under the effect of gravity.

In the case of advantageous embodiments, the spring element is supported, on the one hand, on the movable locking element and, on the other hand, on the unit or the holder.

In the case of an advantageous embodiment, the first locking element is mounted in a rotatable manner on a housing of the unit. However, it is in principle also possible for the first locking element to be mounted in a rotatable manner on the unit itself or on the holder. The second spring element typically comprises a spring which is fastened on the first locking element and is supported on the housing of the unit. As an alternative, it is also possible for the spring element to be fastened on the second locking element and/or to be supported on the unit itself or on the holder.

In the case of a typical locking device, the first latching element comprises a latching nose for engaging in an aperture and/or a latching opening of the holder. As an alternative or in addition, it is also possible for the second latching element or the second locking element to comprise a latching nose for engaging in an aperture and/or a latching opening of the housing of the unit or of the unit itself.

In the case of advantageous embodiments, the first latching element and/or the second latching element comprise/comprises a stop edge for striking against the second stop.

It is particularly advantageous if the first latching element and/or the second latching element comprise/comprises a first insertion slope for facilitating insertion of the unit into the holder. In the case of advantageous embodiments, the first insertion slope is arranged between the latching nose and the stop edge.

In the case of particularly advantageous embodiments, the first latching element and/or the second latching element comprise/comprises a second insertion slope for facilitating insertion of the unit into the holder. In the case of typical embodiments, the second insertion slope is arranged behind the first insertion slope and/or the stop edge, as seen from the latching nose.

In the case of an advantageous locking device, the first stop is formed by the holder and/or the second stop is formed by the holder. In addition, or as an alternative, it is also possible for the stops to be formed by the housing of the unit or by the first locking element.

In the case of advantageous embodiments, the second locking element is formed by the aperture of the holder. This has the advantage that the holder itself need not comprise any movable parts, and this simplifies the handling and maintenance thereof.

A unit according to the invention for mounting a holder advantageously comprises at least one first locking element according to the invention.

A holder according to the invention for accommodating a unit typically comprises at least one second locking element according to the invention.

### DESCRIPTION OF THE FIGURES

The invention will be explained in more detail hereinbelow with reference to figures, in which:

FIG. 1 shows a perspective view of a unit which is locked in a holder with the aid of a locking device according to the invention;

FIG. 2 shows a side view of a unit which is locked in a holder with the aid of a locking device according to the invention;

FIG. 3 shows a side view of a latching element of a locking device according to the invention (on a vastly enlarged scale);

FIG. 4 shows a perspective view of a locking device according to the invention which is mounted on the inner side of a unit housing;

FIG. 5 shows a side view of a locking device according to the invention at the beginning of an insertion operation;

FIG. 6 shows a side view of a locking device according to the invention during an insertion operation;

FIG. 7 shows a side view of a locking device according to the invention at the end of an insertion operation;

FIG. 8 shows a side view of a locking device according to the invention at the beginning of a pulling-out operation;

FIG. 9 shows a side view of a locking device according to the invention during a pulling-out operation;

FIG. 10 shows a side view of a locking device according to the invention with a unit not introduced correctly into a holder;

FIG. 11 shows a perspective view of a locking device according to the invention which is mounted on the inner side of a unit housing and is in its starting position;

FIG. 12 shows a perspective view of a locking device according to the invention which is mounted on the inner side of a unit housing and is in its locking position;

FIG. 13 shows a perspective view of a locking device according to the invention which is mounted on the inner side of a unit housing and is in its maximum position;

FIG. 14 shows a perspective view of a further exemplary embodiment of a locking device according to the invention, this one having two first and two second locking elements; and

FIG. 15 shows an enlarged detail of the locking device from FIG. 14.

### DESCRIPTION OF A PREFERRED EXEMPLARY EMBODIMENT

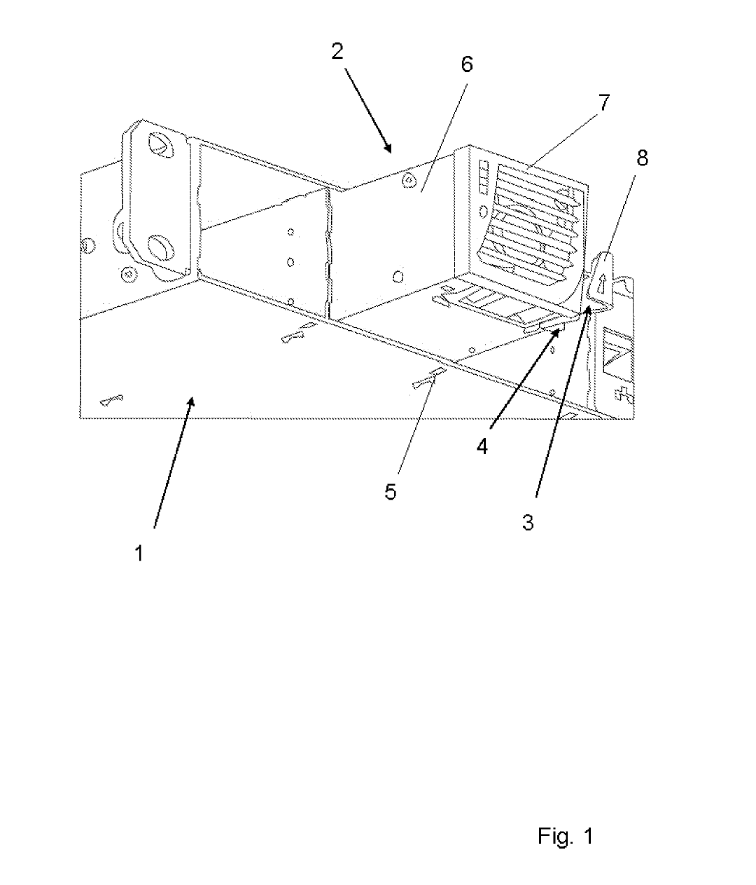

FIG. 1 shows a unit 2 which can be locked in a holder 1 with the aid of a locking device according to the invention. The unit 2 comprises a unit housing 6, a front element 7 and a locking element 3. The locking element 3 comprises a latching element 4 and an operating lug 8, for moving and/or operating the locking device. The latching element 4 is formed such that it can engage in a latching opening 5. This engagement of the latching element 4 in the latching opening 5 locks the unit 2 in the holder 1. The latching element 4 is formed such that it cannot project beyond the latching opening 5 at all. As a result, it is not possible at all for the unit 2 locked in the holder 1 to prevent a further unit from being plugged into the holder 1 if the latching element 4 is projecting out of the latching opening 5.

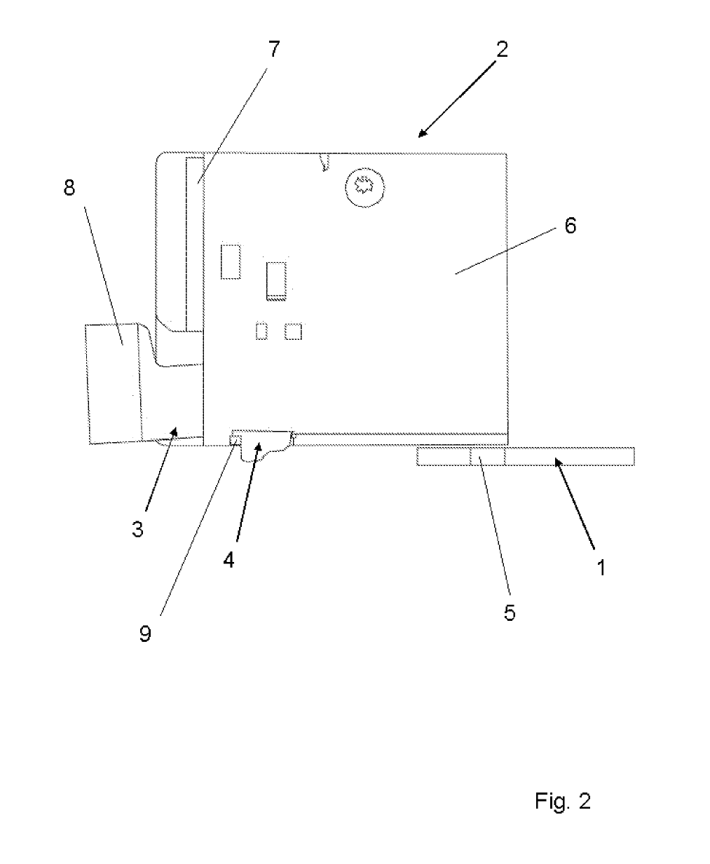

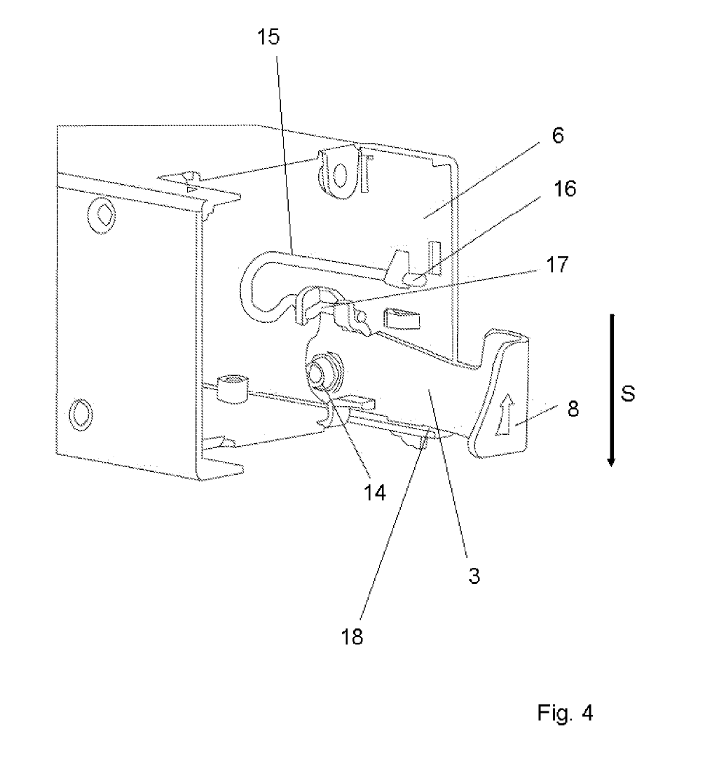

FIG. 2 shows a side view of a locking device according to the invention for locking a unit 2 in a holder 1, the unit comprising a front element 7, a unit housing 6 and a locking element 3. In order to lock the unit 2 in the holder 1, the latching element 4 has to come into engagement with the latching opening 5. FIG. 2 shows the locking device or the locking element 3 in its starting position. The locking element 3 can be subjected to a force by a spring element 15 (see FIG. 4), and therefore the locking element 3 is pushed onto a first stop 9. In the exemplary embodiment shown, the first stop 9 is part of the unit housing 6.

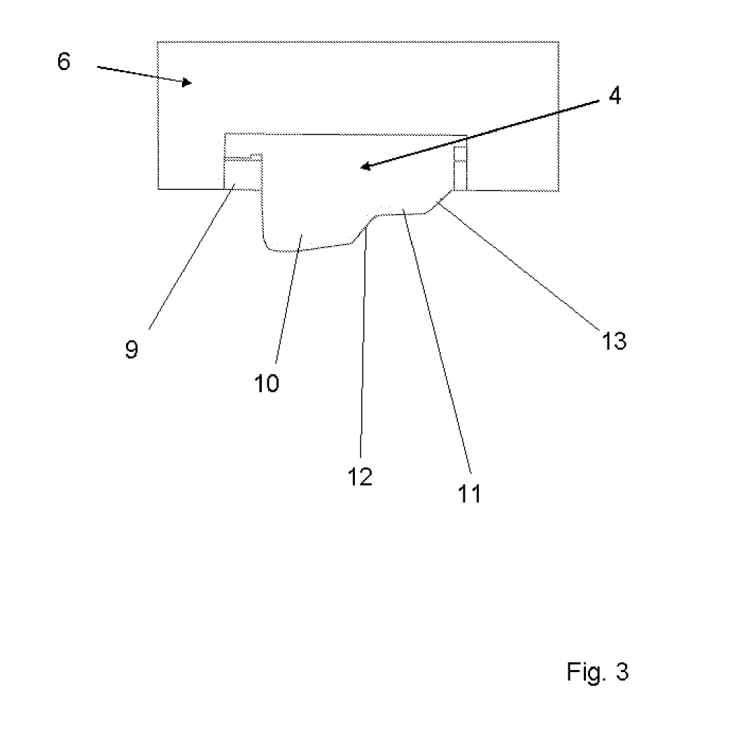

FIG. 3 shows a side view of a latching element 4 of a locking device according to the invention (on a vastly enlarged scale). It can be seen in FIG. 3 that the latching element 4 comprises a latching nose 10, a stop edge 11 and a first insertion slope 12 and a second insertion slope 13. The first insertion slope 12 is arranged between the latching nose 10 and the stop edge 11. The second insertion slope 13 is arranged at that end of the latching element 4 which is opposite to the latching nose 10. The latching element 4 projects, at least in part, through a through-passage 9 of the unit housing 6.

FIG. 4 shows how the locking element 3 is fastened on an inner side of the unit housing 6 with the aid of a spring element 15 and of a rotary fastening means 14. The rotary fastening means 14 connects the locking element 3 to the unit housing 6, and the spring element 15 braces the spring element 3 against the unit housing 6. At a housing fastening 16, the spring element 15 engages beneath a lug. At a locking-element fastening 17, the spring element 15 is fastened on the locking element 3. In the starting position of the locking device, which is shown in FIG. 4, the spring element 15 pushes the locking element 3 onto the first stop 18 of the unit housing 6. If one wanted to move the locking element 3 away from the first stop 18, then the operating lug 8 would have to be actuated counter to the stressing direction S. The spring element 15 would be compressed in this case.

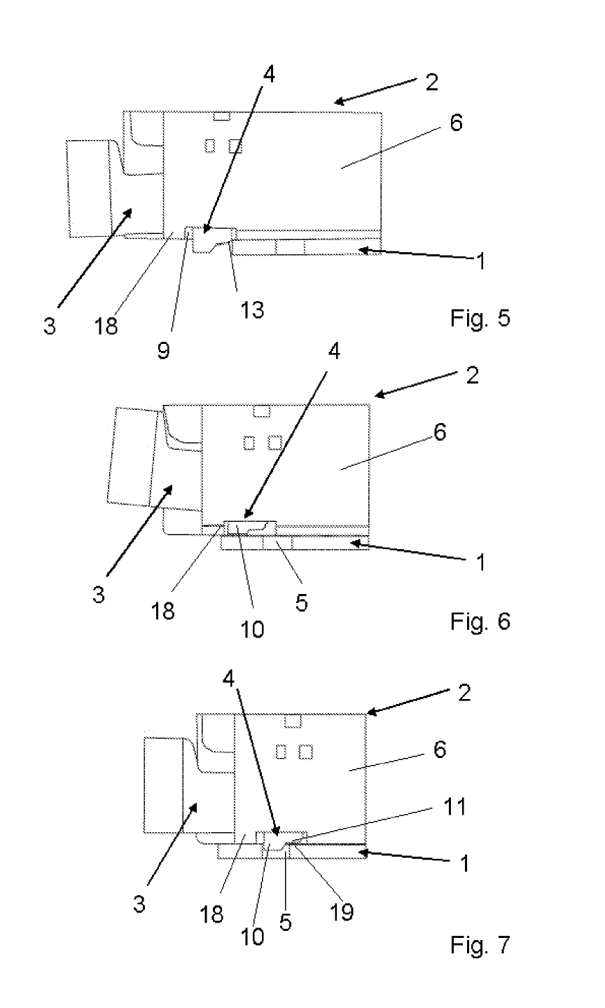

FIGS. 5-7 illustrate an operation for inserting the unit 2, with a locking device according to the invention, into the holder 1. FIG. 5 shows the unit 2 and the holder 1 at the beginning of the insertion operation. It can be seen that the locking element 3 strikes against the first stop 18 of the unit housing. The latching element 4 of the locking element 3 projects through the through-passage 9 of the unit housing 6. In that position of the unit 2 which is shown in FIG. 5, the second insertion slope 13 strikes against a front edge of the holder 1. If the operation of plugging the unit 2 into the holder 1 were continued from the position which is shown in FIG. 5, then the latching element 4 would run gradually along the front edge of the holder 1, by way of its second insertion slope 13, until the stop edge 11 (for reasons of clarity, not depicted in FIG. 5) rests on the inner side of the holder 1. FIG. 6 shows the unit 2 and the holder 1 during the insertion operation. The locking element 3 in FIG. 6 no longer rests on the first stop 18 of the unit housing 6; rather, the fact that the latching element 4 has its latching nose 10 resting on the upper side of the holder 1 means that the locking element 3 is oriented upward, i.e. away from the first stop 18 of the unit housing 6. If the operation of plugging the unit 2 into the holder 1 were continued further, then the latching element 4, finally, would come into engagement with the latching opening 5 of the holder 1. This so-called locking position of the locking device is illustrated in FIG. 7. It can be seen in FIG. 7 that the latching nose 10 of the locking element 4 engages in the latching opening 5 of the holder 1, wherein the stop edge 11 of the locking element 4 rests on a second stop 19 of the locking device, in particular the holder 1. It can also be seen in FIG. 7 that the locking element 3 does not rest on the first stop 18 of the unit housing 6; rather, the locking element 3 and the first stop 18 are spaced apart. If necessary, it would thus be possible for the spring element 15 (see, for example, FIG. 4, but not shown in FIG. 7) to push the locking element 3, in the locking position, down onto the first stop 18 and thus to push the latching element 4 yet further through the through-passage 9 (for the sake of clarity, not depicted in FIG. 7).

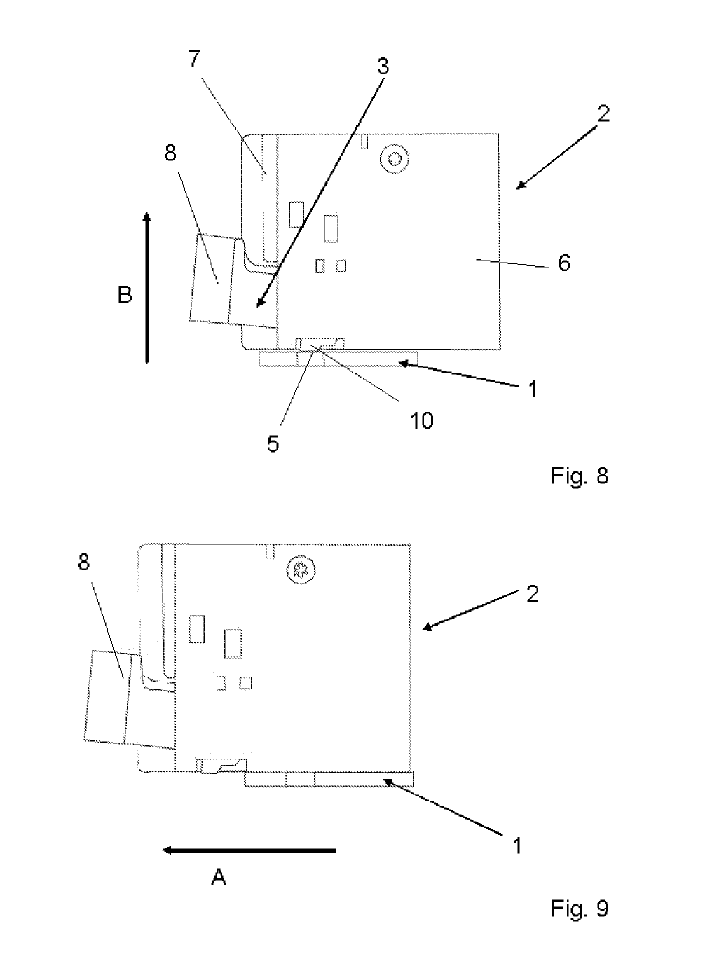

FIGS. 8 and 9 portray an operation for pulling the unit 2 out of the holder 1. FIG. 8 here shows the beginning of the pulling-out operation, in the case of which the operating lug 8 is moved in the actuating direction B and thus the locking element 3 is deflected upward in relation to FIG. 8. As a result, the latching nose 10 is raised out of the latching opening 5 of the holder 1. By virtue of the further upwardly deflected operating lug 8 being pulled in the pulling-out direction A, the unit 2, with the unit housing 6, front element 7 and locking element 3, can be pulled out of the holder 1. This continued pulling-out operation is illustrated in FIG. 9.

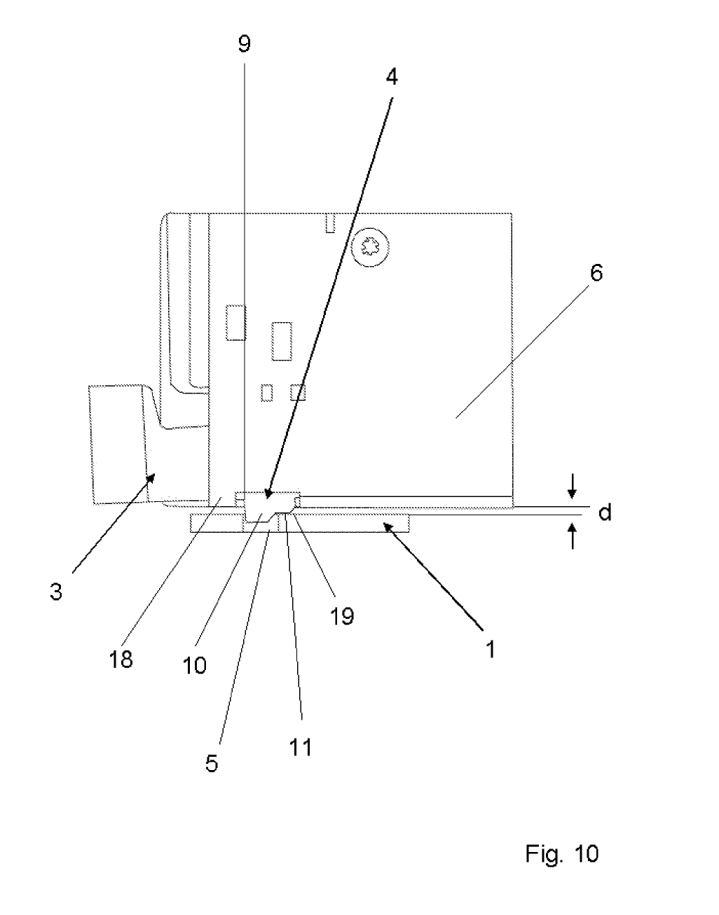

FIG. 10 illustrates a case in which the unit housing is not plugged correctly into the holder 1. The incorrect position of the unit housing 6 in relation to the holder 1 is manifested, inter alia, by a spacing d between an inner side of the holder 1 and a lower outer side of the unit housing 6. In this case which is shown in FIG. 10, the locking element 3, then, has been pushed further in the direction of the first stop 18 of the unit housing 6 than is the case in the locking position, which is shown in FIG. 7. As a result, the latching element 4 is also pushed further through the through-passage 9 of the unit housing 6 than is the case in FIG. 7. It is thus ensured that, even if the unit housing 6 is not positioned correctly in relation to the holder 1, as shown in FIG. 10, the latching nose 10 engages in the latching opening 5 to such an extent that the unit 2 is locked securely in the holder 1. At the same time, the interaction between the stop edge 11 of the latching element 4 and the second stop 19 of the locking device or of the holder 1 prevents the latching nose 10 from projecting beyond the latching opening 5, and thus an underside of the holder 1, as a result of which the operation of a further unit being plugged in a compartment of the holder 1 beneath the unit 2 which is shown in FIG. 10 would not be compromised.

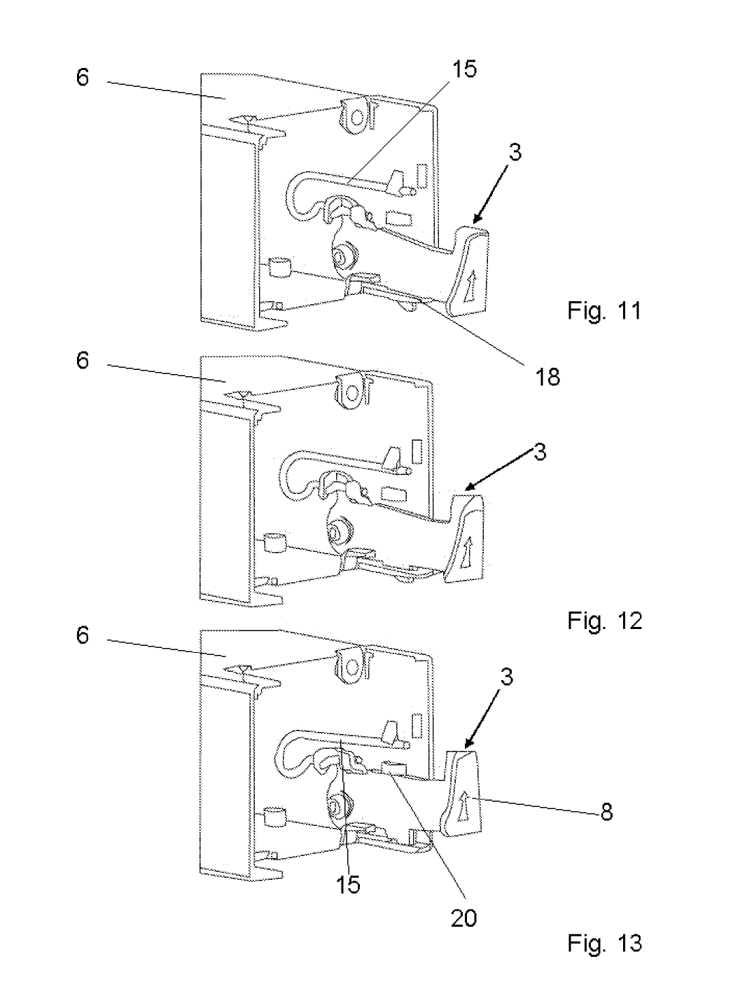

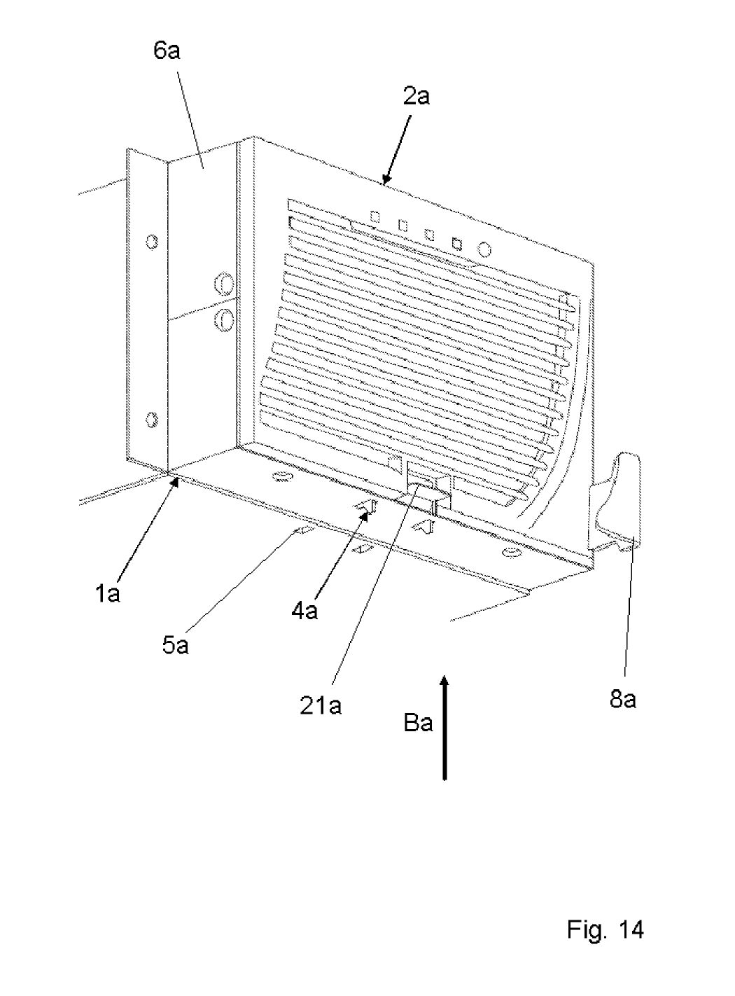

FIGS. 11-13, then, show perspective views of the starting position (FIG. 11), the locking position (FIG. 12) and the maximum position (FIG. 13) of a locking device according to the invention which is mounted on the inner side of the unit housing 6. In the starting position, which is shown in FIG. 11, the spring element 15 is relieved of stressing to the maximum extent and the locking element 3 strikes against the first stop 18 of the unit housing 6. In the locking position, which is shown in FIG. 12, the locking element 3 is positioned centrally. In the maximum position, which is shown in FIG. 13, the locking element 3 is deflected upward to the maximum extent with the aid of the operating lug 8, and therefore the locking element 3 strikes against a limiting stop 20 of the unit housing 6. The spring element 15 here is compressed to the maximum extent. FIG. 14 shows a perspective view of a further exemplary embodiment of a locking device according to the invention, this one having two first and two second locking elements. It is also the case that the exemplary embodiment which is shown in FIG. 14 shows a unit 2a which is plugged into a holder la. In contrast to the exemplary embodiment which is illustrated in FIGS. 1 to 13, the unit 2a comprises two latching elements 4a arranged essentially in the center of the unit 2a. These latching elements 4a are suitable for coming into engagement, in a locking position of the locking device, with a respective latching opening 5a of the holder 1a. The construction of the latching elements 4a is essentially the same as the construction of the latching element 4 illustrated in FIGS. 1 to 13. The unit 2a comprises an unlocking lever 21a. This unlocking lever 21a is connected to the two latching elements 4a (not shown explicitly in FIG. 14). The unlocking lever 21a is designed as a spring element, as a result of which the unlocking lever 21a itself and the two latching elements 4a are prestressed in the direction of a base of the unit housing 6a. As an alternative, the locking device which is illustrated in FIG. 14 could also comprise a separate spring element for prestressing the unlocking lever 21a and the two latching elements 4a in the direction of the base of the unit housing 6a. In order to unlock a unit 2a which has been locked in the holder 1a, the unlocking lever 21a has to be actuated in the actuating direction Ba. As a result, the latching elements 4a move out of the latching openings 5a. In order to pull the unit 2a out of the holder 1a, it is then possible, with the unlocking lever 21a actuated, for the unit 2a to be pulled out of the holder 1a by the operating lug 8a, which is fixed to the unit 2a. It is thus the case that two hands are necessary for pulling the unit 2a out of the holder 1a, that is to say one hand being necessary for unlocking purposes and the other for pulling-out purposes. This has the advantage that it is not possible for the unit 2a to be pulled out using one hand, as a result of which proper and reliable handling of the unit is always ensured. As an alternative to such a spaced-apart arrangement of the unlocking lever 21a and operating lug 8a, which requires the use of both hands in order to remove the unit 2a from the holder 1a, it would also be possible for the unlocking lever 21a and operating lug 8a to be arranged closely enough to allow the unit 2a to be pulled out of the holder 1a using a single hand. It would also be possible for the unlocking lever 21a itself to comprise an operating lug for pulling the unit 2a out of the holder 1a, in which case a separate operating lug could be dispensed with. These two alternative options could be advantageous, in particular, in the case of small and/or lightweight plug-in units.

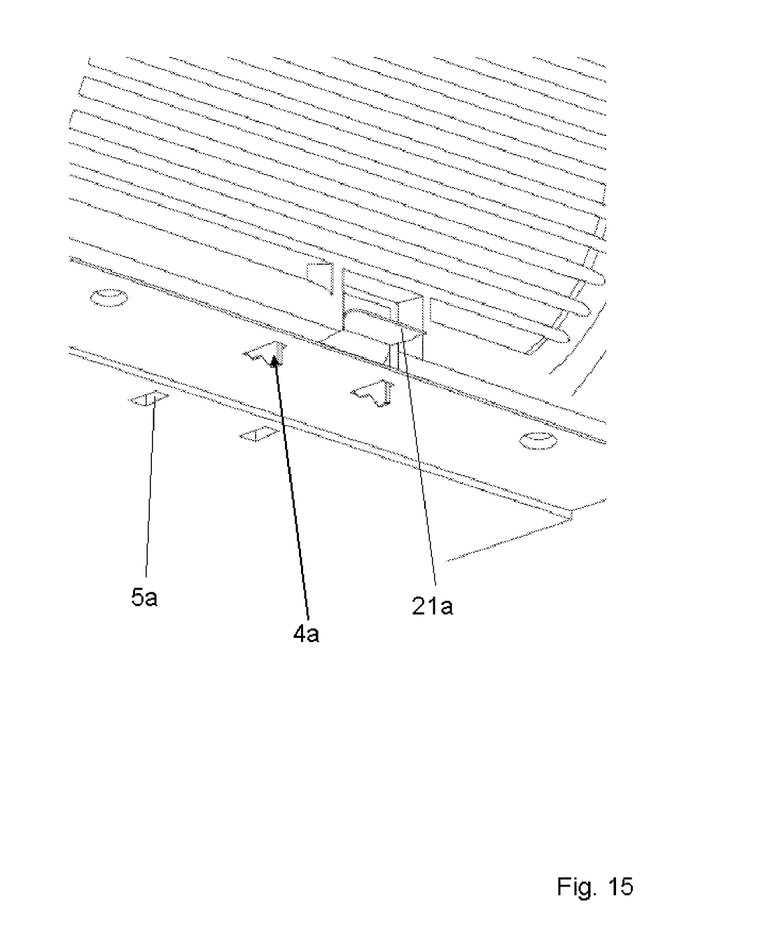

FIG. 15 shows an enlarged detail of the locking device from FIG. 14.

The invention is not restricted to the exemplary embodiments shown here; rather, the scope of protection is determined by the patent claims.

1.-15. (canceled)

16. Device for locking a unit in a holder, having a first locking element, which has a first latching element and is contained by the unit, and having a second locking element, which has a second latching element and is comprised by the holder, wherein
at least one of the locking elements is mounted in a movable manner and may be subjected to a force for the purpose of locking the two latching elements,
the locking device comprises a first stop, for limiting maximum deflection of the movable locking element in the direction of the force, and
the locking device comprises a second stop for limiting overlapping of the two latching elements in the locked state.

17. Locking device according to claim 16, wherein the two stops are arranged such that, when the two locking elements are being locked, the movable locking element strikes against the second stop before it strikes against the first stop.

18. Locking device according to claim 16, wherein the locking device further comprises a spring element for subjecting the movable latching element to the force.

19. Locking device according to claim 16, wherein the spring element is supported, on the one hand, on the movable locking element and, on the other hand, on the unit or a housing of the unit or on the holder.

20. Locking device according to claim 16, wherein the first locking element is mounted in a rotatable manner on the housing of the unit and the spring element comprises a spring which is fastened on the first locking element and is supported on the housing of the unit.

21. Locking device according to claim 16, wherein the first latching element comprises a latching nose for engaging in an aperture of the holder.

22. Locking device according to claim 21, wherein the first latching element comprises a stop edge for striking against the second stop.

23. Locking device according to claim 16, wherein the first latching element comprises a first insertion slope for facilitating insertion of the unit into the holder.

24. Locking device according to claim 23, wherein the first insertion slope is arranged between the latching nose and the stop edge.

25. Locking device according to claim 16, wherein the first latching element comprises a second insertion slope for facilitating insertion of the unit into the holder.

26. Locking device according to claim 25, wherein the second insertion slope is arranged behind the first insertion slope or the stop edge, as seen from the latching nose.

27. Locking device according to claim 16, wherein the first stop is found by the housing of the unit and the second stop is formed by the holder.

28. Locking device according to claim 21, wherein the second locking element is formed by the aperture of the holder.

29. A unit for mounting in a holder, comprising a first locking element which has a first latching element and is contained by the unit.

30. A holder for accommodating a unit, comprising a second locking element which has a second latching element and is comprised by the holder.

31. Locking device according to claim 25, wherein the second insertion slope is arranged behind the first insertion slope and the stop edge, as seen from the latching nose.
